(19) United States
(12) Patent Application Publication
(10) Pub. No.: US 2009/0285062 A1
(43) Pub. Date: Nov. 19, 2009

(54) Method for Rearranging Back-Up Data

(75) Inventors: Shih-Kuo Chen, Guishan Shiang (TW); Chin-Fa Hsu, Guishan Shiang (TW); Shiu-Ming Chu, Guishan Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: Quanta Storage Inc., Guishan Shiang (TW)

(21) Appl. No.: 12/391,650

(22) Filed: Feb. 24, 2009

(30) Foreign Application Priority Data
May 15, 2008 (TW) 097118285

(51) Int. Cl. G11B 19/02; G11B 27/02; G11B 27/36

(52) U.S. Cl. 369/47.12; 369/47.13; G9B/19.001; G9B/27.004; 369/83; 369/53.15

(57) ABSTRACT

The invention discloses a method for rearranging back-up data, which first starts rearranging a back-up area when a rewritable optical disc is loaded, reads all available replacing blocks on the back-up area, rearranges the order of the replacing blocks based on the order of addresses of corresponding data blocks on the user data area, writes the rearranged replacing blocks into a planned area of the back-up area, and registers the corresponding information to finish the operation of rearrangement for rapidly reading data.

### FIELD OF THE INVENTION

The present invention relates to a method for rearranging back-up data, and in particular to a method of rearrangement by backing up data into the back-up area and rearranging it, when the optical disk drive is loaded with an optical disc.

### BACKGROUND OF THE INVENTION

The conventional recordable optical disc offers a defect managing mechanism to correctly back up the data of the defect blocks that has been soiled, scratched or damaged on the optical disc, and to write them into the back-us area, in order to replace the defect blocks with the back-up data and read the data of the optical disc successfully.

FIG. 1(a) and FIG. 1(b) show the conventional process of backing up the defect data on an optical disc. Referring to FIG. 1(a), the data tracks of the conventional optical disc 10 are disposed from the outer circle to the inner circle, and they sequentially are lead-in area 11, first back-up area 12, user data area 13, second back-up area 14 and lead-out area 15. When the control unit 16 of an optical disk drive receives the command of data writing from the host, the control unit 16 receives the needed data for writing, then saves them to the buffer memory area 17 and further plans a cache memory area 18 in the memory. Subsequently, the pick-up head 19 will be moved to write the received data clusters into the planned data blocks in the user data area 13, and the data block 1, 2, 3, 4 and 5 are formed after writing in several times.

As a result of the random way in writing the rewritable optical disc, data written on the planned data blocks on the user data area 13 in each writing would not follow the consecutive address order of the data block on the user data area 13. For instance, data clusters for the first time writing are written into the data block 1 as planned where no defect is found by verification, and data clusters for the second time writing are planned to be written into the data block 5 where defects are found by verification. In this cases the pick-up head 19 moves to the first back-up area 12 to write the correct data clusters saved in the buffer memory area 17 into the replacing block A as back-up data, and the corresponding addresses of the data block 5 and the replacing block A are registered on the defect management list (not shown) of the lead-in area 11.

Data clusters for the third time writing are planned to be written into the data block 2 where defects are found by verification, and the correct data is written into the replacing area B as a back-up data and registered on the defect management list. Data clusters for the fourth time writing are planned to be written into the data block 3 where defects are found by verification, and the correct data is written into the replacing area C as a back-up data and registered on the defect management list. Data clusters for the fifth, i.e. the last time writing are written into the data block 4 as planned where no defect is found by the verification. Hence the order of the replacing blocks A, B and C of the back-up area co-responding to data blocks 5, 2 and 3, is different from the order of data blocks as 2, 3 and 5.

Referring to step (1) to step (8) shown by FIG. 1(b), the solid line represents the movement for reading by the pick-up head 19, and the dotted line means for the movement for simply moving by the pick-up head 19. When the control unlit 16 of the optical disk drive receives the command for reading data on the optical disc 10 from the host, in step (1), the control unit 16 moves the pick-up head 19 to the user data area 13 to search for the needed data, sequentially read the data, and successfully read the data block 1 where no defect is found. In step (2), when it comes to the defected data block 2, the control unit 16 checks whether the replacing block “B” exists in the cache memory area 18 corresponding to the data block 2. The defected data block 2 will be replaced with the replacing block B if it is exist, or the pick-up head 19 will move to the replacing block B of the first back-up area 12 according to the corresponding address registered on the defect management list. In step (3), the replacing block B has been read to replace the defected data block 2, while the pick-up head 19 moves forward to read the several replacing blocks next to the replacing block B, and to save them in the cache memory area 18 as a cache data. Thus the replacing block C has been read as a cache data.

In step (4), the pick-up head 19 moves back to the data block 3 of the user data area 13. In step (5), as a result of the defect data block 3, the control unit 16 checks whether the replacing block C exists in the cache memory area 18. Having been read as a cache data in step (3), the replacing block C could be read in cache for replacement, and the pick-up head 19 continuously moves to read the data block 4 where no defect is found. In step (6), when it comes to the defected data block 5, the control unit 16 checks whether the replacing block A exists in the cache memory area 18 corresponding to the data block 5. The pick-up head 19 moves to the replacing block A of the first back-up area 12, and then reads the replacing block A to replace the defected data block 5 in step (7). In the last step, step (8), the pick-up head 19 moves back to the user data area 13, and is ready for receiving the next command for reading other data blocks to accomplish reading the needed data.

However, the conventional process of backing up the defect data hardly keeps the same address orders of the replacing block of the back-up area and the corresponding data block of the user data area because of the random way, in multiple writing the rewritable optical disc. Because the forward-moving pick-up head cannot read the replacing block in a reverse order and backward while reading the particular replacing blocks of the back-up area, the optical disk device needs to move the pick-up head back and forth between the user data area and the back-up area and needs to repeat those servo actions like track-jumping and track-locking that increases the time of reading and decreases the overall efficiency of the optical disk drive. Hence there are still problems to be solved on the arrangement of the back-up area order of the conventional process in backing up the defect data on the optical disc.

### SUMMARY OF THE INVENTION

An objective of the present invention is to provide a method for rearranging back-up data, which rearranges and rewrites the whole replacing blocks of the back-up area in the order of the corresponding data block while the optical disc is loaded, in order to smoothly read the cache data, decrease the time in moving pick-up head for reading data, and increase the data reading efficiency.

Another objective of the present invention is to provide a method for rearranging back-up data, which chooses to run the function of rearranging the back-up area while the optical disc is loaded, in order to increase the flexibility in use.

In order to achieve the foregoing objectives of the invention, a method for rearranging back-up data according to the present invention is provided, which includes starting and operation of rearrangement for a back-up area while a rewritable disc is loaded, reading all available replacing blocks in the back-up area, rearranging the replacing blocks based on the order of addresses of corresponding data blocks of the user data area, writing the rearranged replacing blocks into a planned area in the back-up area, registering the corresponding information, and finishing the operation of rearrangement for rapidly reading data.

A further embodiment of the present invention is to provide a method for rearranging a back-up area, which includes loading an optical disc into an optical disk device, identifying if the optical disc is a rewritable optical disc, checking for the need of rearranging the back-up data, starts rearranging, starting an operation of rearrangement, reading all the replacing blocks available for backing up in the back-up area, rearranging the replacing blocks based on the order of the corresponding data blocks of the user data area, rewriting the rearranged replacing blocks into the back-up area, registering the corresponding information and finishing the operation of rearrangement.

### BRIEF DESCRIPTION OF THE DRAWINGS

FIG. 1(a) and FIG. 1(b) are diagrams showing the conventional process of backing up the defect data on an optical disc;

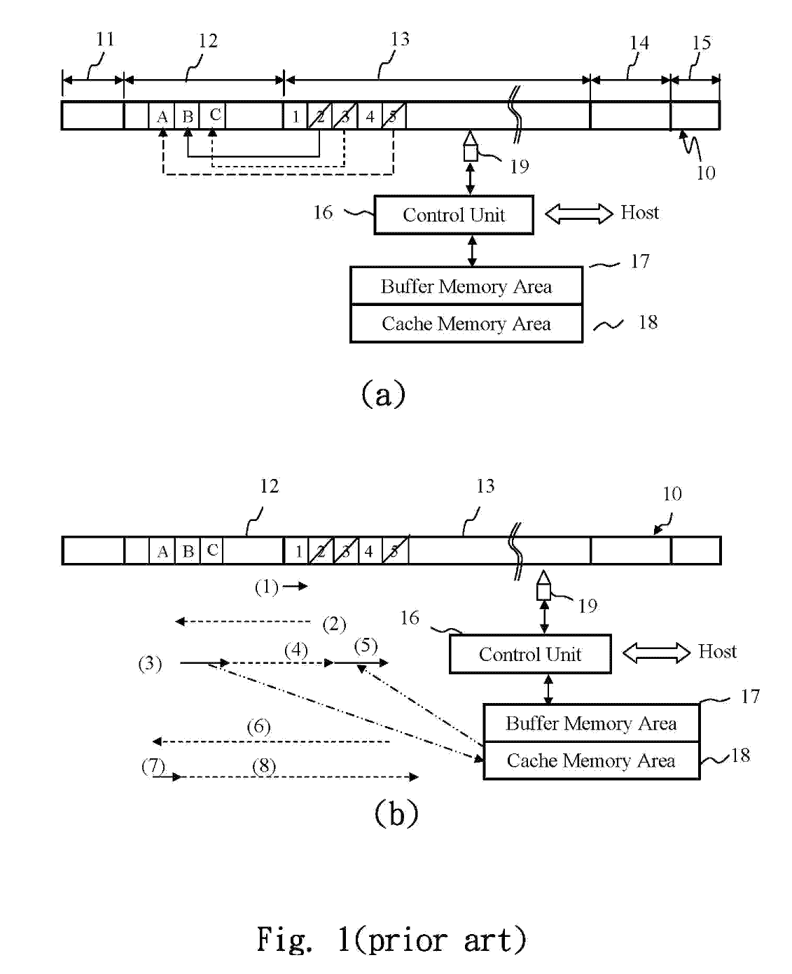

FIG. 2(a) and FIG. 2(b) are diagrams showing the process of rearranging back-up data according to the first embodiment of the invention;

FIG. 3 is a flow chart showing a method of rearranging back-up data according to the first embodiment of the present invention;

FIG. 4 is a diagram showing the process of reading the back-up data according to the first embodiment of the present invention; and

FIG. 5 is a flow chart showing a method of rearranging back-up data according to the second embodiment of the present invention.

### DETAILED DESCRIPTION OF THE INVENTION

The techniques employed by the present invention to achieve the foregoing objectives and the effects thereof are described hereinafter by way of examples with reference to the accompanying drawings.

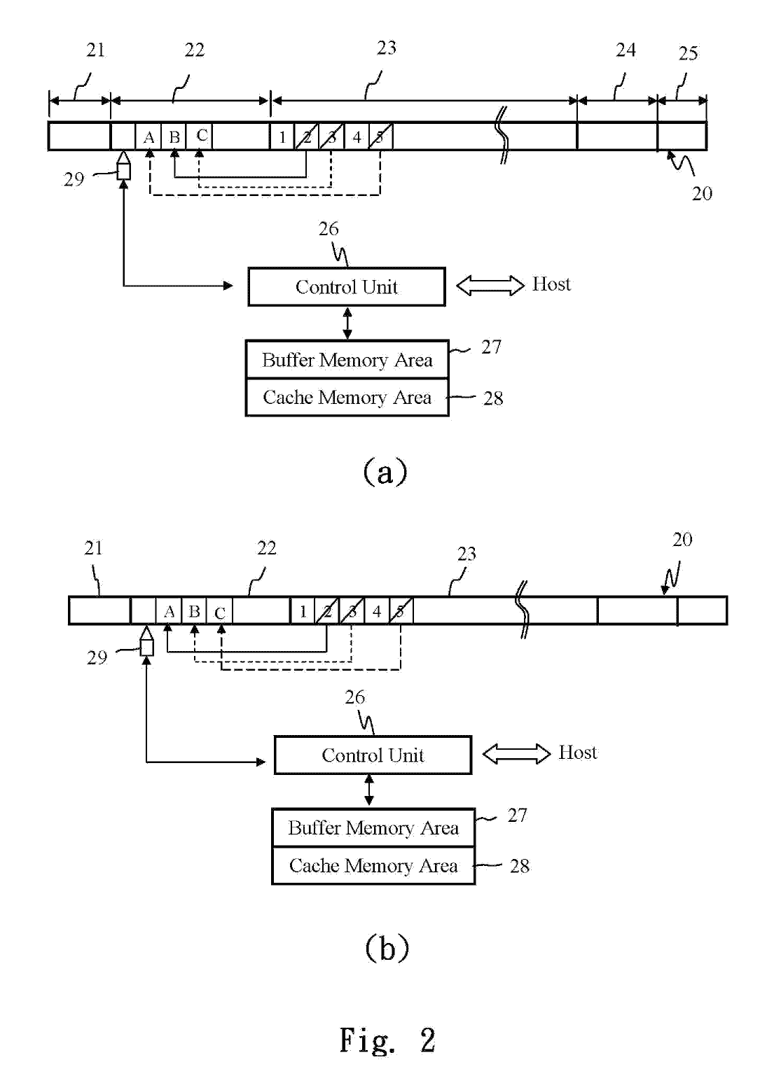

FIG. 2(a) and FIG. 2(b) shows the process of rearranging back-up data according to the first embodiment of the present invention. Referring to FIG. 2(a), the present invention uses a rewritable optical disc 20, and data tracks from the outer circle to the inner circle sequentially are lead-in area 21, first back-up area 22, user data area 23, second back-up area 24 and the lead-out area 25. When the control unit 26 of the optical disk device receives the command from the host, the control unit 26 cooperates with the memory including buffer memory area 27 and the cache memory area 28 to control the pickup head 29 in reading the data on the optical disc 20. Data was written on the optical disc 20 in a way, for example, that the data are written into the data block 1, 2, 3, 4 and 5 of the user data area, and the defected data blocks 5, 2 and 3 are randomly backed up to the first back-up area corresponding to replacing blocks A, B and C, so the order of the replacing blocks A, B and C is different from the order (such as an order of address) of the data block 2, 3 and 5 of the user data area 23.

When the optical disk device is loaded with the optical disc 20, the control unit 26 automatically runs the rearrangement on the back-up area. The control unit 26 moves the pick-up head 29 to the first back-up area 22 and the second back-up area 24 to read the replacing blocks A, B and C that is available for backing up all the defected data blocks on the back-up area, and to store them into the buffer memory area 27 according to the corresponding information registered on the defect management list of the lead-in area 21, and then all the available replacing blocks A, B and C in the buffer memory area 27 are rearranged in the order of data blocks 2, 3 and 5 based on the order of the addresses of the corresponding data blocks 5, 2 and 3 of the user data area 23 exactly are.

Then, referring to FIG. 2(b), the control unit 26 moves the pick-up head 29 to rewrite the rearranged replacing blocks stored in the buffer memory area 27 into the planned area of the back-up area, and the planned area could be as a whole or in part of the original back-up area. After rewriting the new back-up data of the replacing blocks A, B and C, the replacing block A becomes the back-up data of the data block 2, the replacing block B becomes the back-up data of the data block 3 and the replacing block C becomes the back-up data of the data block 5. The new order of the replacing blocks A, B and C is in the same order of the addresses of the corresponding defected data blocks 2, 3 and 5 of the user data area 23, which takes advantages that the pick-up head 29 could read the data blocks in the front order first and then smoothly reads the replacing blocks in the rear order as a cache data.

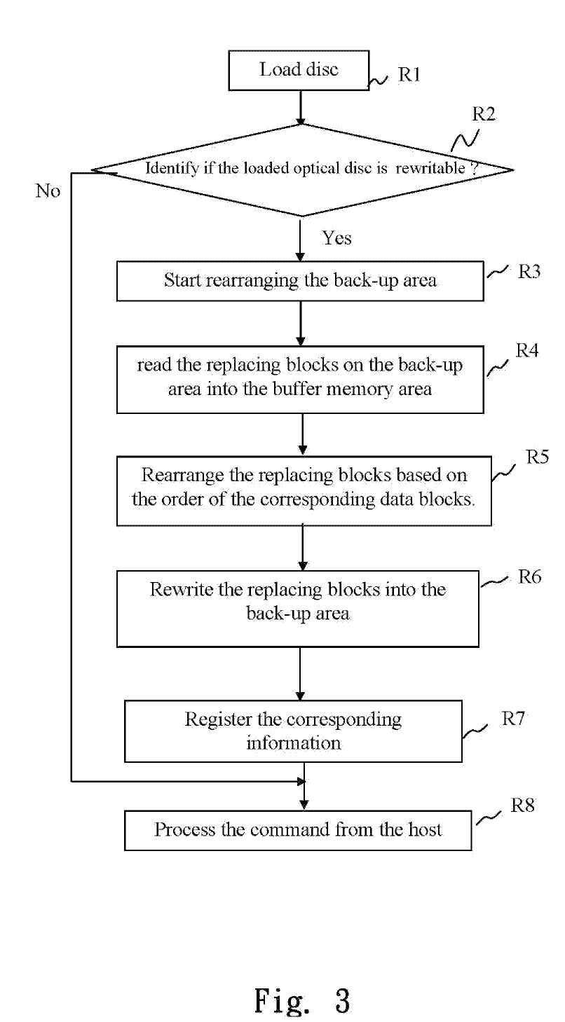

FIG. 3 is a flow chart showing a method of rearranging back-up data according to the first embodiment of the present invention. The present invention rearranges the replacing blocks in the back-up area when the optical disc is loaded, to takes advantages of reading the cache data, which comprises following steps: in step (R1), loading a optical disc into a optical disk device; in step (R2), identifying if the loaded optical disc is a rewritable optical disc, and then performing step (R3) to rearrange the optical disc if it is rewritable, or performing step (R8) to stop the rearrangement; in step (R3), starting an operation of rearrangement for the back-up area and moving the pick-up head to the back-up area; in step (R4), reading all the available replacing blocks of the back-up area into the buffer memory area, based on the corresponding address information registered on the defect management list of the lead-in area; in step (R5), rearranging the replacing blocks in the buffer memory area based on the order of the addresses of the corresponding data blocks of the user data area; in step (R6), moving the pick-up head by the control unit to rewrite the rearranged replacing blocks of the buffer memory area into the back-up area, and unifying the order of the rearranged replacing blocks and the order of the corresponding defected data blocks of the user data area; in step (R7), registering the addresses of the rearranged replacing blocks of the back-up area and the corresponding data blocks of the user data area, on the defect management list of the lead-in area in order to provide a reference for reading and writing the data on the optical disc; after completion of the rearrangement, in step (R8) finishing the operation of the rearrangement and waiting for the next command from the host.

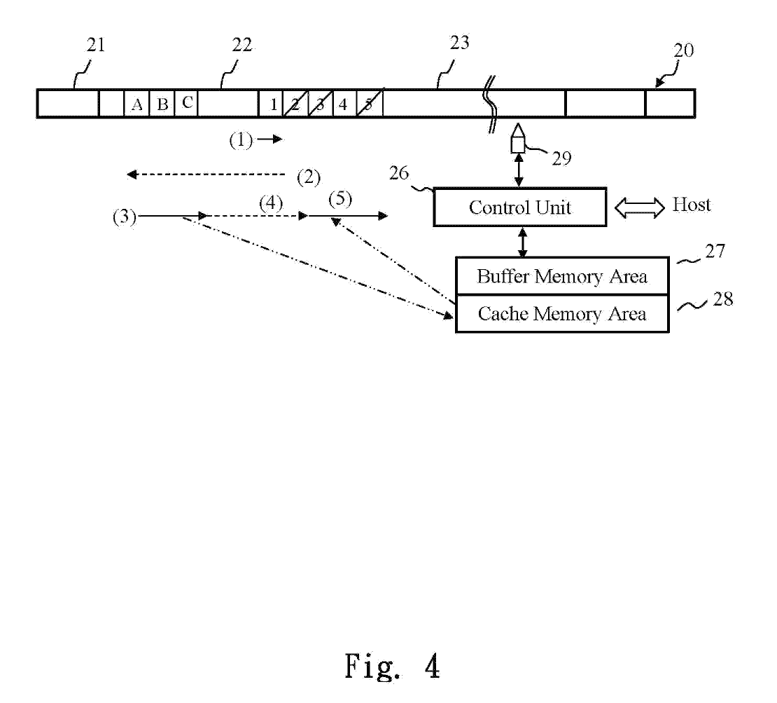

FIG. 4 is a diagram showing the process of reading the back-up data according: to the first embodiment of the present invention. Referring to Steps (1) to (5) shown by FIG. 4, the solid line represents the movement for reading of the pick-up head 26, and the dotted line means for the movement for simply moving of the pick-up head 26. When the control unit 26 receives the command of reading data on the optical disc 20 from the host, in step (1) the pick-up head 29 moves to the user data area 23 to search the needed data and to sequentially read the needed data block 1. When it comes to the defected data block 2, in step (2), the control unit checks whether the replacing block A exists in the cache memory area 28 according to the corresponding address information on the defect management list. Because no replacing block A corresponding to the data block 2 has been found after the foresaid check, the pick-up head 29 moves to the replacing block A of the first back-up area 22. In step (3), the pick-up head 29 reads the replacing block A to write it in place of the defected data block 2, and sequentially reads the next replacing blocks B and C to write them into the cache memory area 28 as cache data. In step (4), the pick-up head 29 moves back to data block 3 to continuously read the data. In step (5), though the data block 3 is a defected data block, the cache data including the replacing block B corresponding to the data block 3 has been found while checking the cache memory area 28; thus, the data block 3 is replaced by the replacing block B directly, and the pick-up head 29 continuously reads the next data block 4 where no defect is found; when it comes to the defect data block, the data block 5 is replaced by the replacing data block C and the needed data will be completely read, as a result of the replacing data block C already included in the cache data in step (3).

Hence a method for rearranging back-up data according to the present invention reads and temporarily stores all the replacing blocks of back-up area on the optical disc into the buffer memory area, rearranges the replacing blocks based on the address order of the data blocks of the user data area, rewrites the rearranged replacing blocks into the back-up area to form back-up data with corresponding address order in order to read the cache data smoothly, and lets the back-up data of the next defected blocks could be read directly in the cache memory area to decrease the time in moving pick-up head between the user data area and the back-up area, decrease the time of reading data, and increase the data reading efficiency.

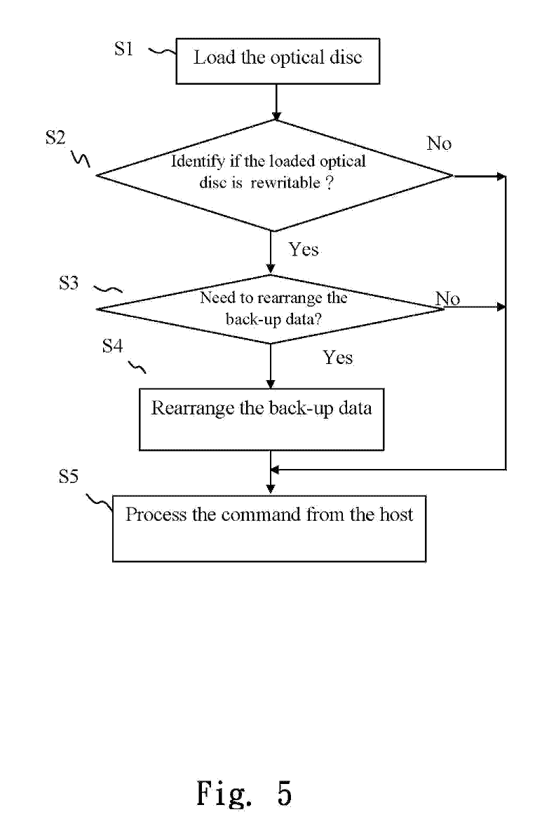

FIG. 5 is a flow chart showing a method of rearranging back-up data according to the second embodiment of the present invention. The second embodiment of the present invention is basically similar to the first embodiment of the present invention, but the difference is that the second embodiment allows users to choose whether there is a need to rearrange the back-up data. The second embodiment of the present invention comprises the following steps: in step (S1), loading a optical disc into a optical disk device; in step (S2), identifying if the loaded optical disc is a rewritable optical disc, and then performing step (S3) to rearrange the optical disc if it is rewritable, or performing step (S5) to stop the rearrangement if it is not rewritable; in step (S3), asking the user to determine if they need to rearrange back-up data, and then performing step (S4) if the user confirms rearranging, or performing step (S5) to stop the rearrangement if user denies rearranging; in step (S4), as in the steps (R4) to (R7) of the first embodiment, rearranging the replacing blocks of the back-up area to unify the order of the rearranged replacing blocks and the order of the addresses of the corresponding defected data blocks of the user data area, and in the last step of step (S5), finishing the operation of the rearrangement and waiting for the next command from the host.

Hence the method of rearranging back-up data according to the second embodiment of the present invention, which provides options for the user to run the rearrangement first or to run the command form the host first according to the priority of data processed by user when the optical disc is loaded, would increase the flexibility in use.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A method for rearranging back-up data by forming replacing blocks in a back-up area on an optical disc for backing up corresponding defected data blocks of a user data area on the optical disc to rearrange a back-up data in the optical disc, the method comprising the steps of:
(a) starting an operation of rearrangement for the back-up area on the optical disc;
(b) reading all the replacing blocks of the back-up area available for backing up the defected data blocks;
(c) rearranging the replacing blocks based on an order of the corresponding data blocks of the user data area;
(d) writing the rearranged replacing blocks into the back-up area;
(e) registering the rearranged replacing blocks and corresponding information of the corresponding data blocks; and
(f) finishing the operation of rearrangement.

2. A method for rearranging back-up data according to claim 1, wherein in step (a), the operation of rearrangement starts when a rewritable optical disc is loaded.

3. A method for rearranging back-up data according to claim 2, further comprising a step of identifying if the optical disc is rewritable when the optical disc is loaded, wherein the operation of rearrangement starts if the optical disc is rewritable, and step (f) is performed if the optical disc is not rewritable.

4. A method for rearranging back-up data according to claim 1, wherein in step (b) all the available replacing blocks of the back-up area are read based on corresponding data registered on a defect management list of a lead-in area on the optical disc.

5. A method for rearranging back-up data according to claim 1, wherein in step (c), the replacing blocks are rearranged based on the order of addresses of the corresponding data blocks of the user data area.

6. A method for rearranging back-up data according to claim 1, wherein in step (d), the rearranged replacing blocks are written into a planned area in the back-up area;

7. A method for rearranging back-up data according to claim 6, wherein the planned area is the original back-up area, and the rearranged replacing blocks are rewritten onto original back-up area.

8. A method for rearranging back-up data according to claim 6, wherein the planned area is parts of the original back-up area.

9. A method for rearranging back-up data according to claim 1, wherein in step (c), the corresponding information is registered as an address data to the defect management list of the lead-in area on the optical disc.

10. A method for rearranging back-up data by forming replacing blocks in a back-up area on an optical disc for backing up corresponding defected data blocks of a user data area on the optical disc to rearrange a back-up data on the optical disc in an optical disk device, comprising the steps of:
(a) loading the optical disc into the optical disk device;
(b) checking if the optical disc needs rearranging, and performing step(c) if the optical disc needs rearranging, or performing step(f) if the optical disc does not need rearranging:
(c) starting an operation of rearrangement and reading all the replacing blocks of the back-up area available for backing up the defected blocks;
(d) rearranging the replacing blocks based on an order of the corresponding data blocks of the user data area, and rewriting the rearranged replacing blocks into the back-up area;
(e) registering the rearranged replacing blocks and corresponding information of the corresponding data blocks; and
(f) finishing the operation of rearrangement.

11. A method for rearranging back-up data according to claim 10, wherein step (a) further comprises identifying if the optical disc is rewritable at first when the optical disc is loaded, wherein the operation of rearrangement starts if the optical disc is rewritable, and step (f) is performed if the optical disc is not rewritable.

12. A method for rearranging back-up data according to claim 10, wherein in step (c), the replacing blocks is read to a memory of the optical disk device.

13. A method for rearranging back-up data according to claim 12, wherein the replacing blocks is rearranged in the memory of the optical disk drive.

14. A method for rearranging back-up data according to claim 10, wherein in step (d), the replacing blocks are rearranged based on the address order of the corresponding data blocks of the user data area.
